(19) United States
(12) Patent Application Publication
(10) Pub. No.: US 2020/0234010 A1
(43) Pub. Date: Jul. 23, 2020

(54) STRUCTURED NATURAL LANGUAGE KNOWLEDGE SYSTEM

(71) Applicants: BIOMEDICAL OBJECTS, INC., Irvine, CA (US); NEC Solution Innovators, Ltd., Tokyo (JP)

(72) Inventors: Chen-Yu SHEU, Irvine, CA (US); Masahiro HAYAKAWA, Tokyo (JP)

(73) Assignees: BIOMEDICAL OBJECTS, INC., Irvine, CA (US); NEC Solution Innovators, Ltd., Tokyo (JP)

(21) Appl. No.: 16/633,392

(22) PCT Filed: Jul. 23, 2018
(86) PCT No.: PCT/US2018/043214

§ 371 Date: Jan. 23, 2020

Related U.S. Application Data
(60) Provisional application No. 62/535,965, filed on Jul. 24, 2017.

(51) Int. Cl. G06F 40/40; G06F 16/2457; G06F 16/33

(52) U.S. Cl. CPC G06F 40/40; G06F 16/3344; G06F 16/24575

(57) ABSTRACT

In a structured natural language (SNL) knowledge system capable of storing SNL sentences in a database. The structured natural language sentence composition module composes an SNL (Structured Natural Language) sentence, and the sentence translator translates an SNL descriptive sentence or an SNL question sentence to SQL (Structured Query Language) queries, and translates the components stored in the database back to the SNL sentence.

This application claims priority based on U.S. Provisional Application No. 62/535,965 filed on Jul. 24, 2017, the disclosures of which are incorporated herein in their entirety.

### TECHNICAL FIELD

The present disclosure relates to a structured natural language knowledge system capable of handling both a descriptive sentence and an interrogative sentence.

### BACKGROUND ART

The Structured Query Language (SQL) is used for relational database systems, for example. It is convenient that a Structured Natural Language (SNL) sentence is automatically translated to SQL sentence. Patent Literature 1 (PTL 1) discloses a structured natural language query and knowledge system including a translator which translates SNL to SQL.

### CITATION LIST

### Patent Literature

### [PTL 1] US2004/0088158

### SUMMARY OF INVENTION

### Technical Problem

However, since the system disclosed in PTL 1 treats only an imperative sentence for generating a query in order to assist a user who lacks programing skill in specifying a query to an application database, the system can only search data from a database. Further, the system is used effectively only when the database stores application data.

An exemplary object of the present invention is to provide a structured natural language system capable of storing sentences in a database retrieving sentences from a database. Further, it is another object of the present invention to create various SNL sentences on the basis of inputted elements by the user.

### Solution to Problem

A structured natural language knowledge system according to the present invention includes: a structured natural language sentence composition module which composes an SNL (Structured Natural Language) sentence, and a sentence translator which translates an SNL descriptive sentence or an SNL question sentence to SQL (Structured Query Language) queries so that the components of a descriptive or question sentence are stored in a database.

An SNL-SQL translation method, the method according to the present invention includes: composing an SNL (Structured Natural Language) sentence, and translating an SNL descriptive sentence or an SNL question sentence to SQL (Structured Query Language) queries so that the components of a descriptive or question sentence are stored in a database.

An SNL-SQL translation program according to the present invention causes a computer to execute: composing an SNL (Structured Natural Language) sentence, and translating an SNL descriptive sentence or an SNL question sentence to SQL (Structured Query Language) queries, and stores the components of an SNL sentence in a database.

### Advantageous Effects of Invention

The present invention can provide a structured natural language system capable of storing SNL sentences in a database, in addition to retrieving SNL sentences from a database. In addition, the present invention can create an SNL sentence based on the elements inputted by the user.

### BRIEF DESCRIPTION OF DRAWINGS

FIG. 1 It depicts a block diagram showing an example embodiment of an SNL knowledge system.

FIG. 2 It depicts an exemplary design of a screen displayed on the display device.

FIG. 3 It depicts exemplary patterns which may be selected from pattern pull-down menu.

FIG. 4 It depicts exemplary tenses which may be selected from the tense pull-down menu.

FIG. 5 It depicts an example of a screen displayed on the display device.

FIG. 6 It depicts a general operation when a descriptive sentence is inputted to the SNL knowledge system.

FIG. 7 It depicts a general operation when a question (question sentence) is inputted to the SNL knowledge system.

FIG. 8 It depicts a general operation when the SNL knowledge system creates a question.

FIG. 9 It depicts a flowchart showing an example of an operation of the structured natural language sentence composition module.

FIG. 10 It depicts an example of a screen displayed on the display device when a positive sentence is made.

FIG. 11 It depicts an example of a screen displayed on the display device when a negative sentence is made.

FIG. 12 It depicts an example of a screen displayed on the display device when an interrogative sentence (yes-no question) is made.

FIG. 13 It depicts an example of a screen displayed on the display device when an interrogative sentence (wh-question) is made.

FIG. 14 It depicts a correspondence table of each element replaced with “what” and interrogative in NL.

FIG. 15 It depicts an example of the operation of the SNL-SQL translator when a descriptive sentence is inputted.

FIG. 16 It depicts an example of the operation of the SNL-SQL translator when a descriptive sentence is inputted.

FIG. 17 It depicts an example of the operation of the SNL-SQL translator when a descriptive sentence is inputted.

FIG. 18 It depicts an example of the operation of the SNL-SQL translator when a question sentence is inputted.

FIG. 19 It depicts an example of the operation of the SNL-SQL translator when a question sentence is inputted.

FIG. 20 It depicts an example of the operation of the SNL-SQL translator when a question sentence is inputted.

FIG. 21 It depicts an example of the operation of the SNL-SQL translator when a question sentence is inputted.

FIG. 22 It depicts an example of the operation of the question generator.

FIG. 23 It depicts an example of the operation of the question generator.

FIG. 24 It depicts an example of the operation of the question generator.

FIG. 25 It depicts an example of the operation of the question generator.

FIG. 26 It depicts a screen when a user inputs elements of an exemplary sentence including a subject and a verb.

FIG. 27 It depicts a screen when a user inputs elements of a sentence including a subject, a verb and a complement.

FIG. 28 It depicts a screen when a user inputs elements of a sentence including a subject, a verb and an object.

FIG. 29 It depicts a screen when a user inputs elements of a sentence including a subject, a verb, an indirect object and a direct object.

FIG. 30 It depicts a screen when a user inputs elements of a sentence including a subject, a verb, an object, and a complement.

FIG. 31 It depicts a screen when a user inputs elements of a comparative sentence (Comparative).

FIG. 32 It depicts a screen when a user inputs elements of a sentence including comparisons of equality (Comparative-Equality).

FIG. 33 It depicts a screen when a user inputs elements of a superlative sentence (Superlative).

FIG. 34 It depicts a screen when a user inputs elements of an adverbial syntax (There is/Here is).

FIG. 35 It depicts a block diagram depicting an information processing system using a program.

### DESCRIPTION OF EMBODIMENTS

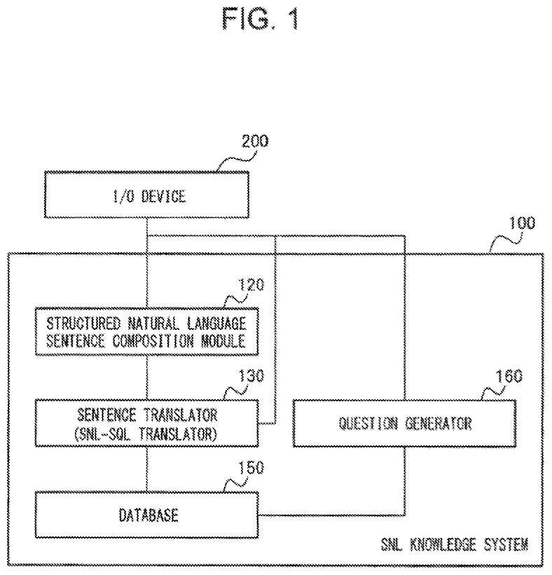

FIG. 1 illustrates an example embodiment of an SNL knowledge system 100 together with an I/O (Input/Output) device 200. The I/O device 200 might include a display (display device), a keyboard for inputting characters and a pointing device for pointing a segment on a screen displayed in the display device.

The SNL knowledge system 100 includes at least a structured natural language sentence composition module 120 which composes an SNL sentence, a sentence translator such as a SNL-SQL translator 130 which translates an SNL sentence to an SQL sentence, a database 150, and a question generator 160 which is another example of the sentence translator. The question generator 160 can create a question on the basis of data stored in the database 150.

First of all, we explain a basic concept of the SNL knowledge system 100.

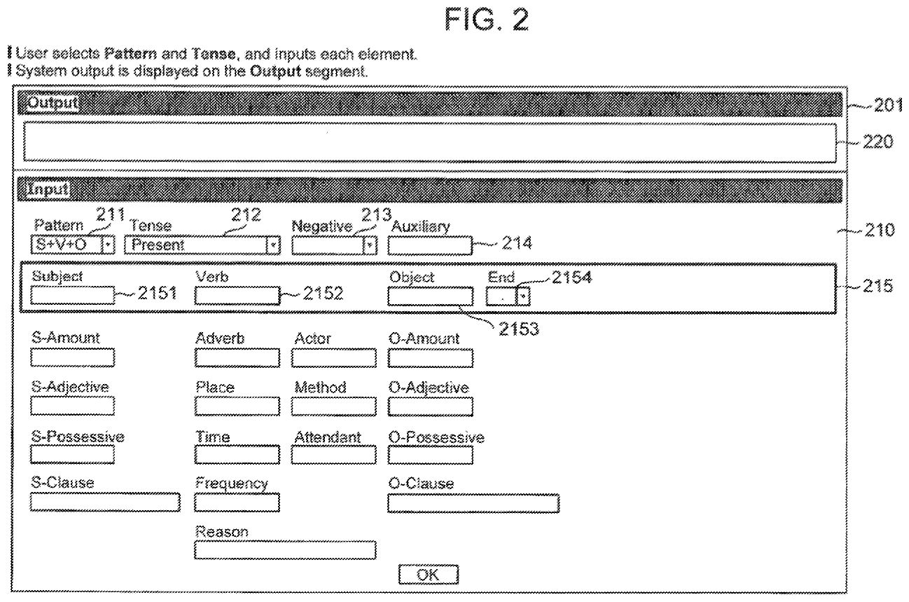

FIG. 2 illustrates an exemplary design of a screen 201 displayed on the display device. In the screen 201 of the example illustrated in FIG. 2, there are an input area (input segment) 210 and an output area (output segment) 220. In the input segment 210, there are a pattern pull-down menu 211, a tense pull-down menu 212, a negative pull-down menu 213, an auxiliary input box 214, and a word input area 215. In the word input area 215, there are a subject input box 2151, a verb input box 2152, an object input box 2153 and a terminator pull-down menu 2154. It should be noted that there are subareas in the screen 201. The subareas are detailed later.

As explained below, when a user selects a pattern and a tense, and inputs one or more elements, the output from the SNL knowledge system 100 is displayed on the output segment 220.

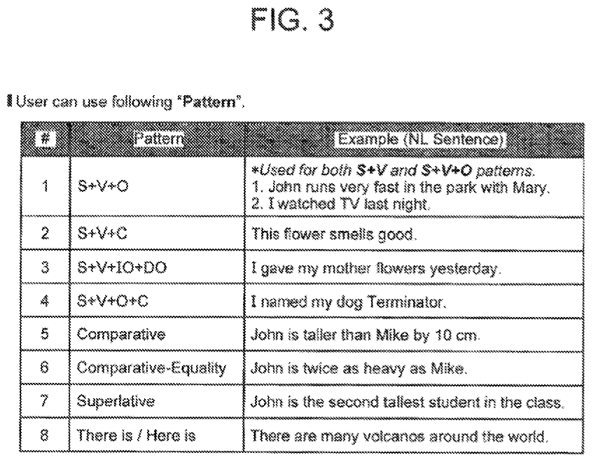

FIG. 3 illustrates exemplary patterns which may be selected from the pattern pull-down menu 211 by the user. In the example, there are eight patterns. In FIG. 3, example NL (natural language) sentences corresponding to respective patterns are illustrated. Each sentence is made from the words inputted by the user to the input segment 210.

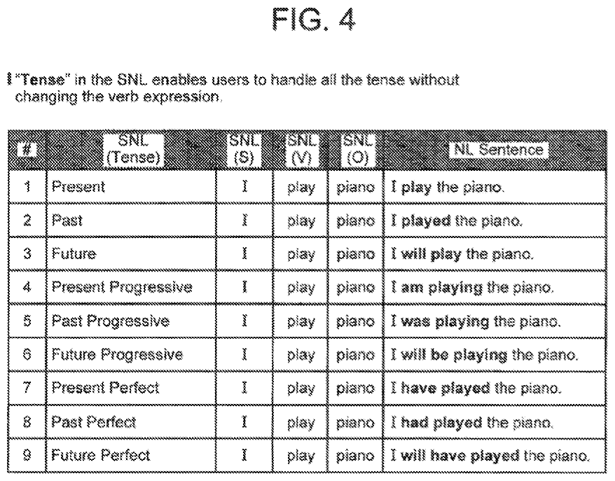

FIG. 4 illustrates exemplary tenses which may be selected from the tense pull-down menu 212 by the user. In the example, the user can choose one of the nine tenses. In FIG. 4, with respect to each tense, an example NL sentence is illustrated. Each sentence is made from the words input by the user to the word input area 215.

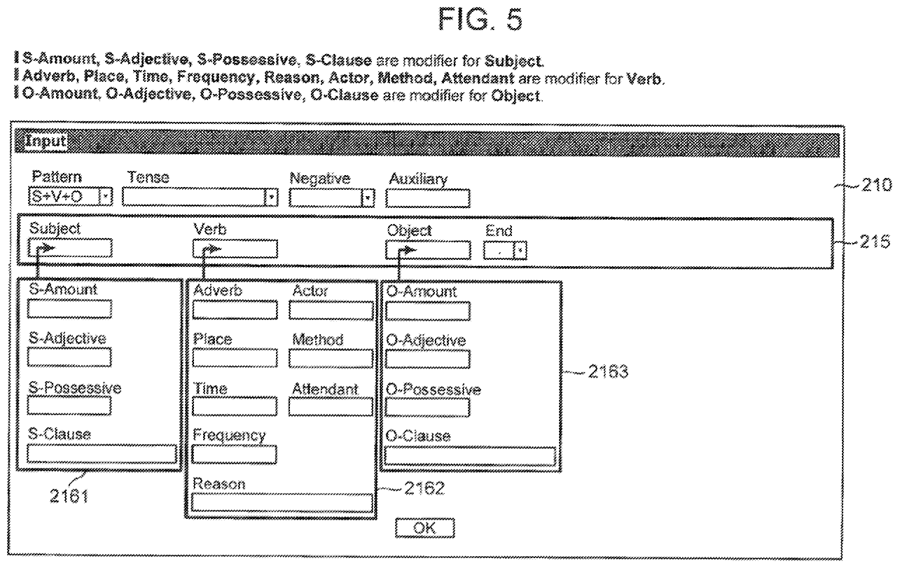

FIG. 5 illustrates an example of a screen 201 displayed on the display device. In the subareas on the screen 201, there are a subject subarea 2161, a verb subarea 2162 and an object subarea 2163, for example.

As shown in FIG. 5, in the subject subarea 2161, there are an S-Amount input box, an S-Adjective input box, an S-Possessive input box, and an S-Clause input box. S-Amount, S-Adjective, S-Possessive, and S-Clause are used as a modifier of “Subject”. In the verb subarea 2162, there are an Adverb input box, a Place input box, a Time input box, a Frequency input box, a Reason input box, an Actor input box, a Method input box, and an Attendant input box. Adverb, Place, Time, Frequency, Reason, Actor, Method, and Attendant are used as a modifier of Verb. In the object subarea 2163, there are an O-Amount input box, an O-Adjective input box, an O-Possessive input box, and an O-Clause input box. O-Amount, O-Adjective, O-Possessive, and O-Clause are used as a modifier of Object.

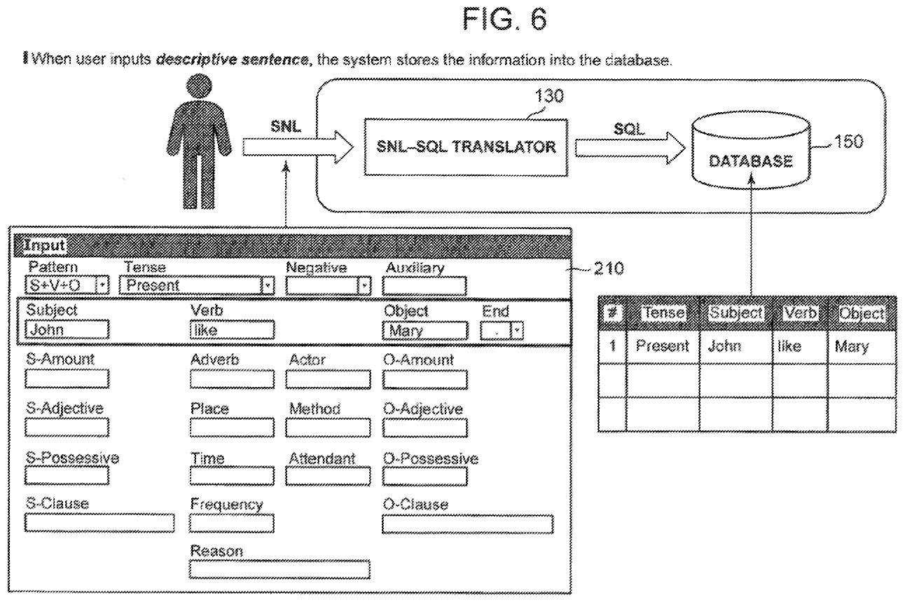

Next, some general operations of the SNL knowledge system 100 are explained, referring to FIGS. 6-8.

### Basic Examples

FIG. 6 illustrates a general operation when a descriptive sentence is inputted to the SNL knowledge system 100. When the user inputs a descriptive sentence, the SNL-SQL translator 130 in the SNL knowledge system 100 stores the components (of the descriptive sentence) into the database 150. In FIG. 6, a following example is shown.

A user selects the “S+V+O” pattern from the pattern pull-down menu 211. The user selects “Present” from the tense pull-down menu 212. The user inputs “John” as the subject. The user inputs “like” as the verb. The user inputs “Mary” as the object. In addition, the user selects “.” (period) as the terminator.

The structured natural language sentence composition module 120 makes an SNL sentence based on the inputted elements. Next, the SNL-SQL translator 130 transforms the SNL sentence to an SQL query, then, stores the information (elements) by SQL into the database 150. For example, the SNL-SQL translator 130 inserts the elements into a table in the database 150.

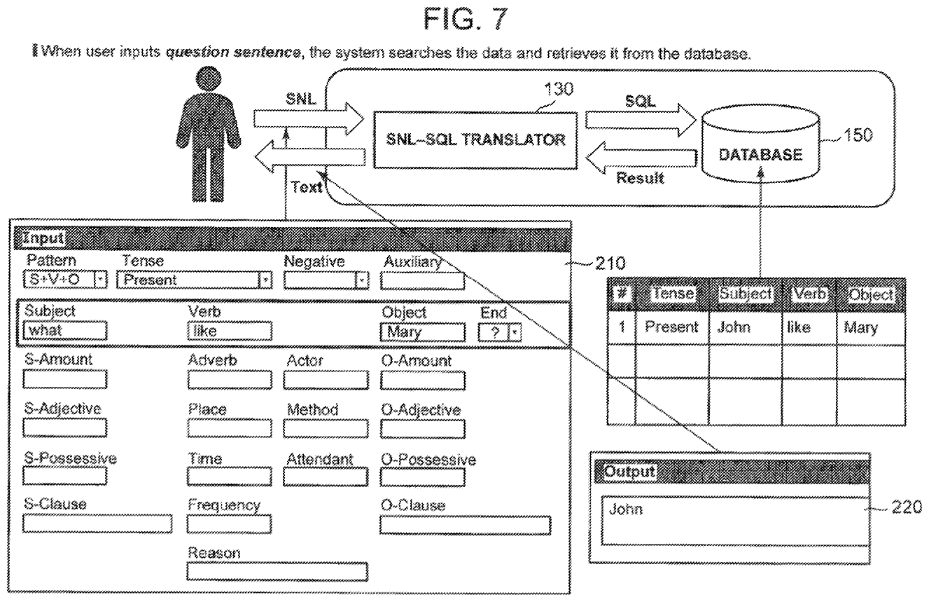

FIG. 7 illustrates a general operation when a question is inputted to the SNL knowledge system 100. When the user inputs a question, the SNL-SQL translator 130 searches the database and retrieve the sentence components from the database 150 that may match the question. In FIG. 7, a following example is shown.

A user selects “S+V+O” from the pattern pull-down menu 211. The user selects “Present” from the tense pull-down menu 212. The user inputs “what” as the subject. The user inputs “like” as the verb. The user inputs “Mary” as the object. In addition, the user selects a question mark (?) as the terminator.

The SNL-SQL translator 130 makes an SNL sentence on the basis of the inputted elements. Further, the SNL-SQL translator 130 transforms the SNL sentence to SQL. The SNL-SQL translator 130 inquires the database 150. Then, the SNL-SQL translator 130 retrieves a result of search from the database 150. The SNL-SQL translator 130 outputs the result. For example, the SNL-SQL translator 130 displays the result on the output segment 220. In FIG. 7, the word “John” is given as the result, for example.

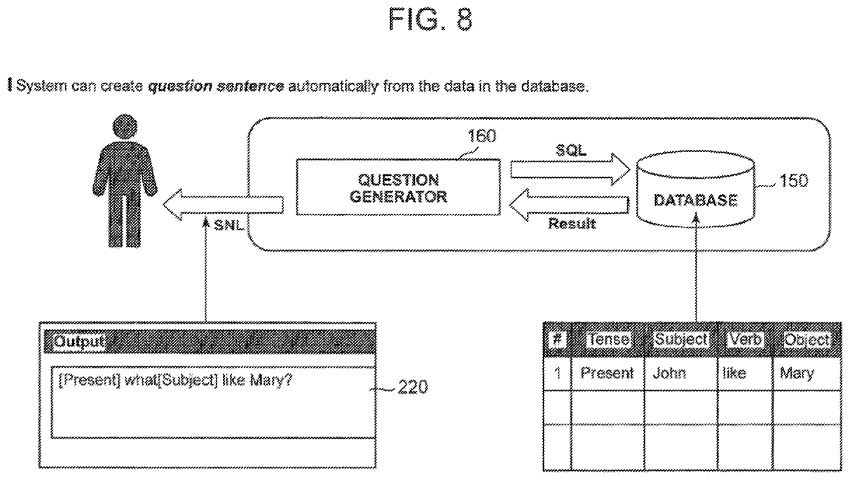

FIG. 8 illustrates a general operation when the SNL knowledge system 100 creates a question. In this example embodiment, the SNL knowledge system 100 can create a question automatically on the basis of the sentences stored in the database 150. In FIG. 8, a following example is shown.

At first, the question generator 160 issues an SQL query to the database. In the example shown in FIG. 8, the question generator 160 can obtain the elements including “Present” as the tense, “John” as the subject, “like” as the verb, and “Mary” as the object from the database 150. The question generator 160 changes an element to “what” for creating a question sentence. In this example, the question generator 160 changes “John” as the subject to “what”. The question generator 160 displays the question (“What like Mary?”) on the output segment 220 as shown in FIG. 8.

### Control Flow of the Sentence Composition Module

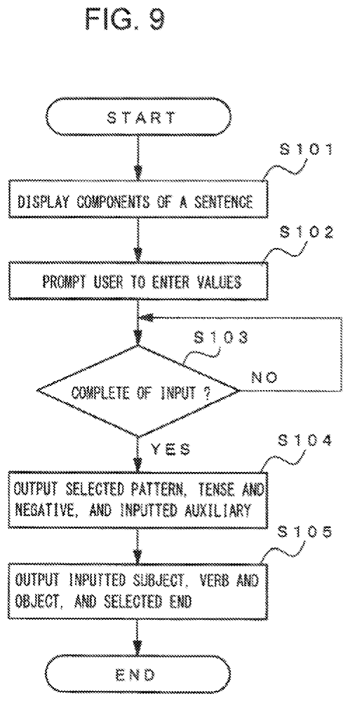

Next, an operation of the SNL knowledge system 100 is explained. FIG. 9 is a flowchart showing an example of an operation of the SNL knowledge system 100, when a user inputs elements of a natural language sentence.

In the SNL knowledge system 100, the structured natural language sentence composition module 120 displays different components of a sentence as shown in FIG. 7, for example (step S101). A component of a sentence may be a subject, an object, a verb, a compliment, an adverb, an adjective, etc. Respective default values are displayed in a pattern pull-down menu 211, a tense pull-down menu 212, a negative pull-down menu 213 and a terminator pull-down menu 2154. It is preferable that the structured natural language sentence composition module 120 prompts the user to enter the values of some or all of the different components in a sentence (step S102). Alternatively the structured natural language sentence composition module 120 prompts the user to choose from a set of possible values of a component. The structured natural language sentence composition module 120 determines whether the input of the user is completed or not (step S103). Specifically, the structured natural language sentence composition module 120 determines whether the “OK” button (refer is FIG. 1, etc.) is clicked or not.

When input of the user is completed, the structured natural language sentence composition module 120 outputs selected elements from the pattern pull-down menu 211, the tense pull-down menu 212, the negative pull-down menu 213, and the inputted element in the auxiliary input box 214 to the SNL-SQL translator 130 (step S103).

The structured natural language sentence composition module 120 outputs the elements inputted by a user for the subject input box 2151, the verb input box 2152, the object input box 2153 to the SNL-SQL translator 130 (step S104).

Further, the structured natural language sentence composition module 120 outputs selected element from the terminator pull-down menu 2154 to SNL-SQL translator 130.

The structured natural language sentence composition module 120 determines whether an end is selected or not (step S105). Specifically, the structured natural language sentence composition module 120 determines whether an element is inputted by a user for the terminator pull-down menu 2154. When an element is inputted, the structured natural language sentence composition module 120 terminates the process shown in FIG. 9 is ended.

Thereafter, the structured natural language sentence composition module 120 composes an SNL sentence based on the inputted elements. The SNL-SQL translator 130 translates an SNL sentence to SQL queries to its components. The SNL-SQL translator 130 stores the inputted elements to the database 150 or searches the data in the database 150 by using SQL.

### Composing Negative Sentences

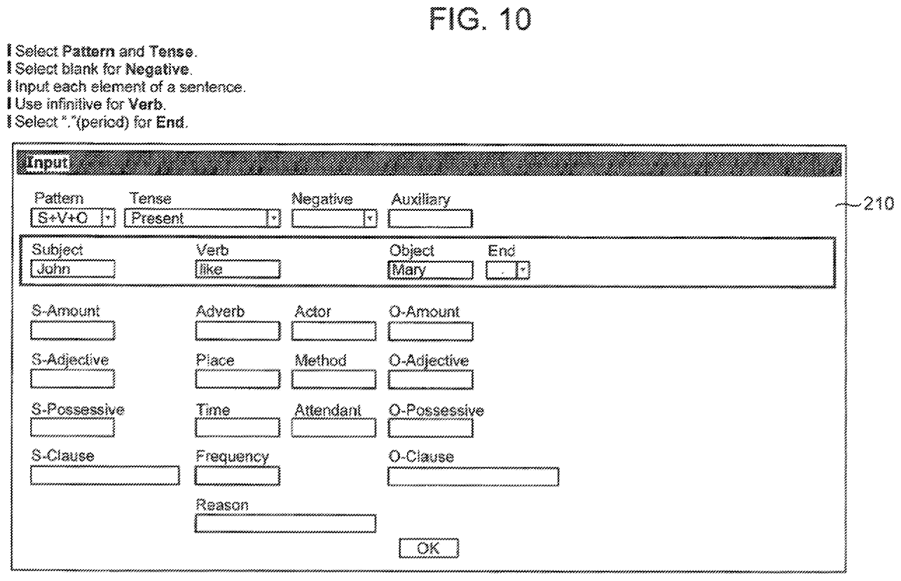

FIGS. 10-13 explain how the structured natural language sentence composition module 120 makes a negative SNL sentence.

In addition, preferably, the structured natural language sentence composition module 120 asks the user to enter the value(s) of one or more components whose value(s) are not known based on what have been entered to develop a more complete sentence incrementally. A component of a sentence may be at least one of a subject, an object, a verb, a compliment, an adverb, and an adjective.

FIG. 10 illustrates an example of a screen displayed on the display device when a positive sentence is made. When a positive sentence is made, a user selects “Pattern” and “Tense”. That is the user selects “S+V+O” from the pattern pull-down menu 211, and “Present” from the tense pull-down menu 212 in this example. The user selects blank for “Negative”. That is the user selects nothing from the negative pull-down menu 213. The user inputs each element of a sentence. That is the user inputs elements in the subject input box 2151, the verb input box 2152, and the object input box 2153. It should be noted that the user can use infinitive for the verb. Finally, the user selects “.” (period) for “End”. That is the user selects “.” (period) from the terminator pull-down menu 2154 for termination.

As described above, the structured natural language sentence composition module 120 receives elements of a positive sentence in SNL.

### Negative Sentences

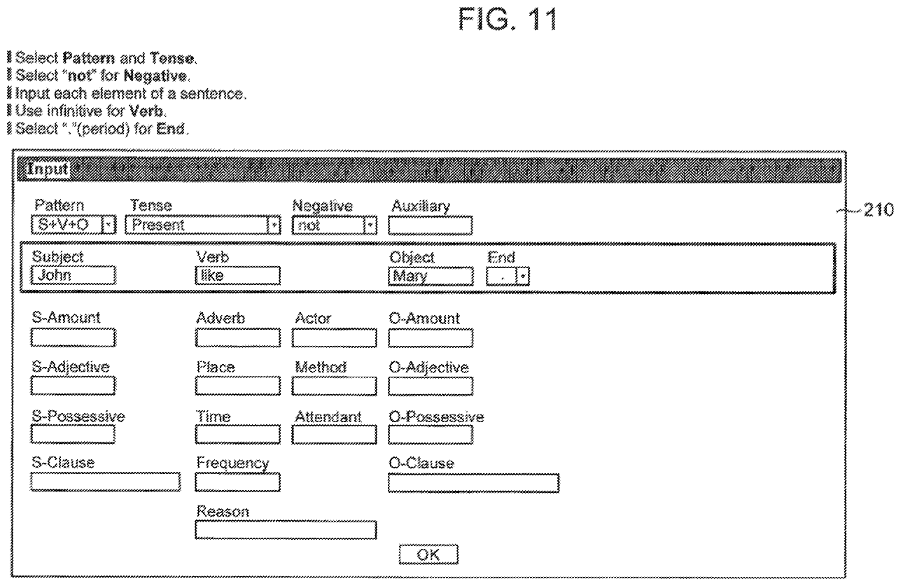

FIG. 11 illustrates an example of a screen displayed on the display device when a negative sentence is made. When a negative sentence is made, the user selects “Pattern” and “Tense”. That is the user selects “S+V+O” from the pattern pull-down menu 211, and “Present” from the tense pull-down menu 212 in this example. The user selects “not” for “Negative”. That is the user selects “not” from the negative pull-down menu 213. The user inputs each element of a sentence. That is the user inputs elements in the subject input box 2151, the verb input box 2152, and the object input box 2153. It should be noted that the user can use infinitive for the verb. Finally, the user selects “.” (period) for “End”. That is the user selects “.” (period) from the terminator pull-down menu 2154 for termination.

As described above, the structured natural language sentence composition module 120 receives elements of a negative sentence of SNL.

### Interrogative Sentences

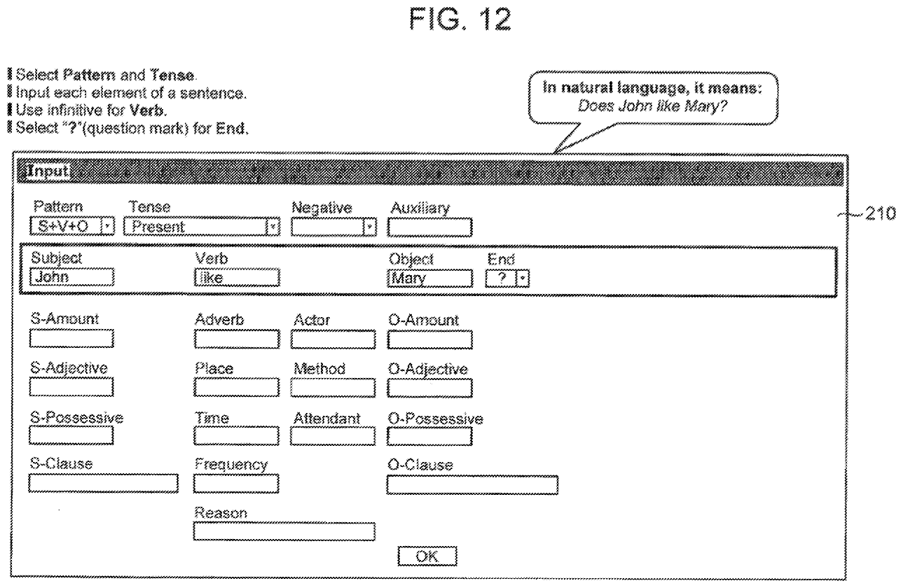

FIG. 12 illustrates an example of a screen displayed on the display device when an interrogative sentence (yes-no question) is made. When an interrogative sentence (yes-no question) is made, the user selects “Pattern” and “Tense”. That is the user selects “S+V+O” from the pattern pull-down menu 211, and “Present” from the tense pull-down menu 212 in this example. The user inputs each element of a sentence. That is the user inputs elements in the subject input box 2151, the verb input box 2152, and the object input box 2153. It should be noted that the user can use infinitive for the verb. Finally, the user selects “?” (question mark) for “End”. That is the user selects “?” (question mark) from the terminator pull-down menu 2154 for termination.

As described above, the structured natural language sentence composition module 120 receives elements of an interrogative sentence (yes-no question) in SNL. Additionally, in the example shown in FIG. 12, the user intends to input “Does John like Mary?” in NL (natural language).

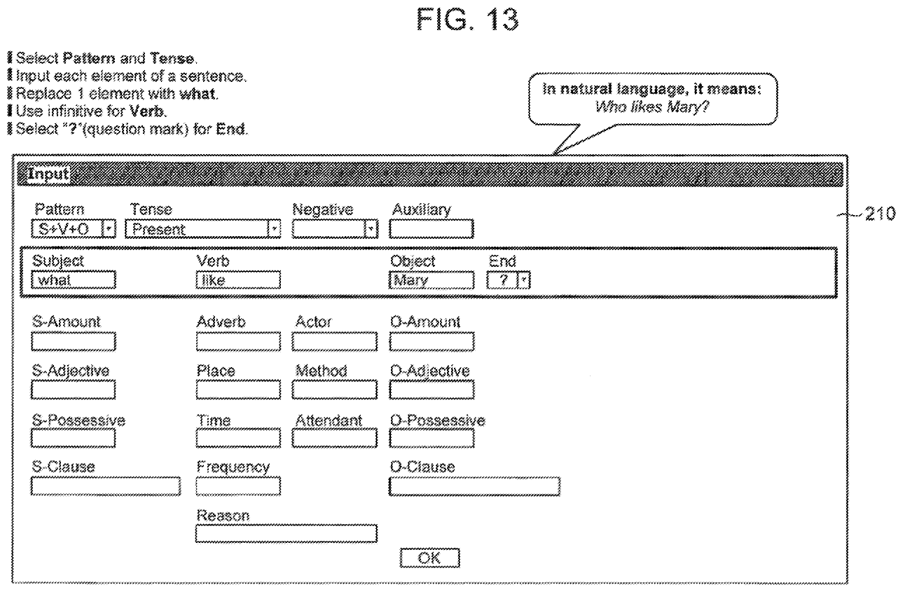

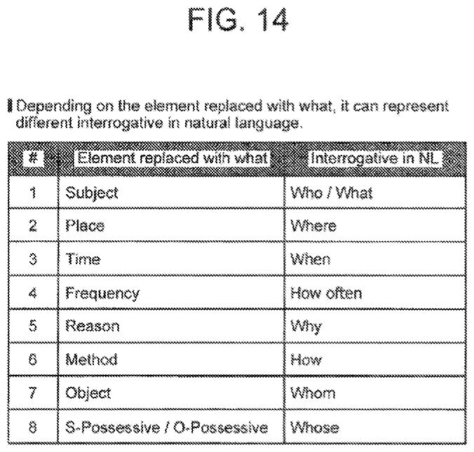

FIGS. 13 and 14 explain how an interrogative sentence (wh-question) is made. FIG. 13 illustrates an example of a screen displayed on the display device when an interrogative sentence (wh-question) is made. When an interrogative sentence (wh-question) is made, the user selects “Pattern” and “Tense”. That is the user selects “S+V+O” from the pattern pull-down menu 211, and “Present” from the tense pull-down menu 212 in this example. The user inputs each element of a sentence. That is the user inputs “what”, “likes” and “Mary” as “Subject”, “Verb” and “Object” in this example.

As described above, the structured natural language sentence composition module 120 receives elements of an interrogative sentence (wh-question) of SNL.

FIG. 14 illustrates a correspondence table of each element replaced with “what” and interrogative in NL.

Given an interrogative sentence, the operations of the SNL-SQL translator 130 are explained now in more detail.

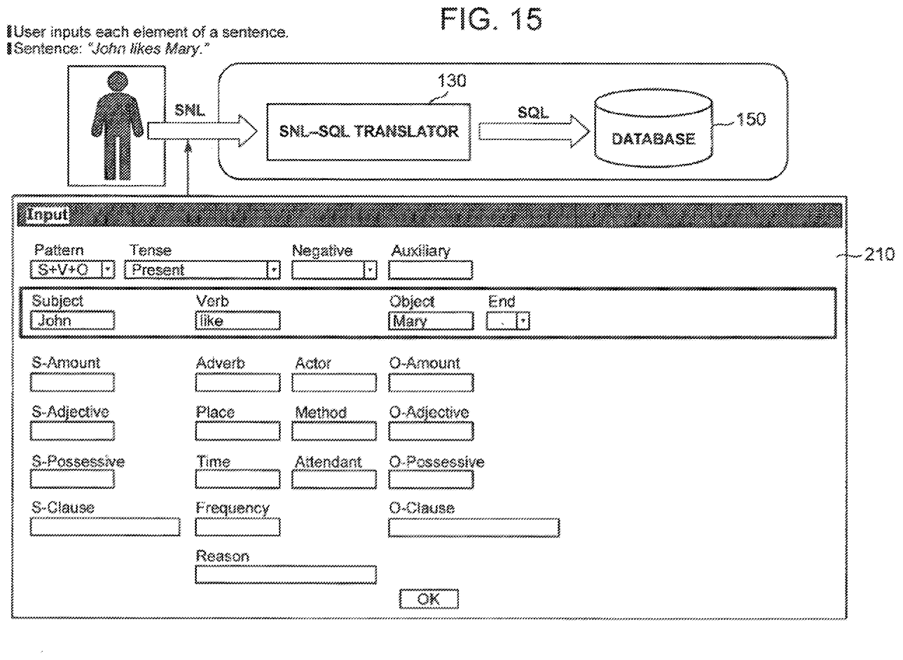

FIGS. 15-17 illustrate an example of the operation of the SNL-SQL translator 130 when a descriptive sentence is inputted. In this example, a user inputs elements of the sentence consisting of “John”, “likes” and “Mary”. As described above, the structured natural language sentence composition module 120 receives elements of an SNL sentence, and output them to the SNL-SQL translator 130 as shown in FIG. 15.

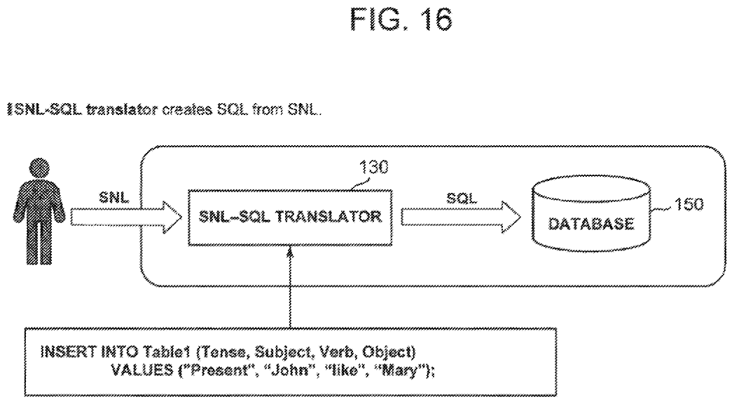

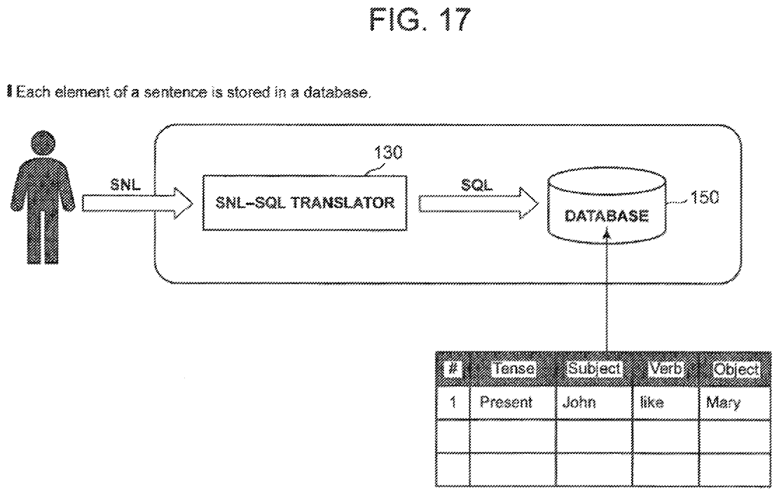

As shown in FIG. 16, the SNL-SQL translator 130 creates SQL queries from SNL. Table 1 includes entries of “Tense”, “Subject”, “Verb” and “Object” as shown in FIG. 17. The SNL-SQL translator 130 inserts “Present”, “John”, “like” and “Mary” into the entries of Table 1.

As shown in FIG. 17, the operation of the SNL-SQL translator 130 stores each element of the sentence in a database 150.

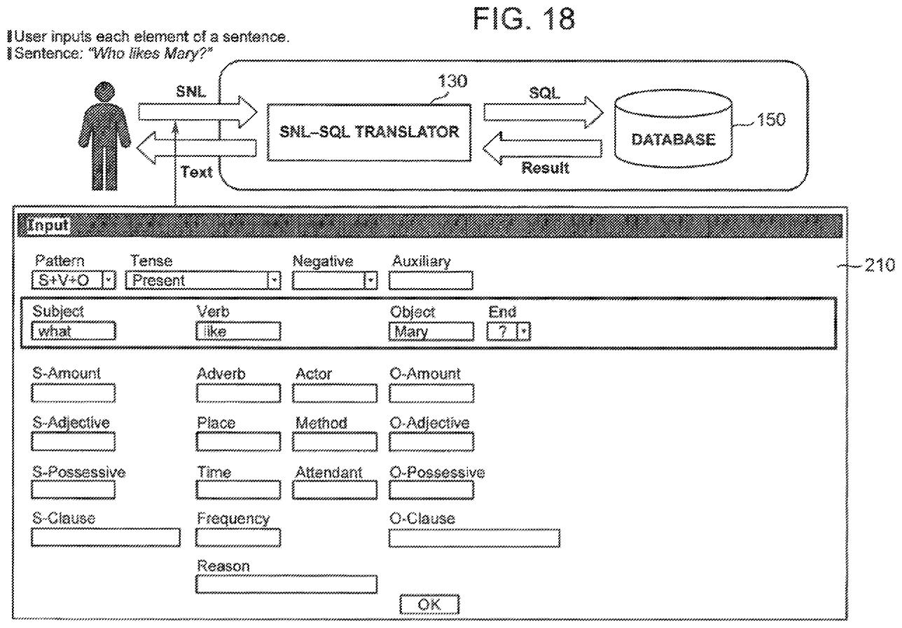

FIGS. 18-21 illustrate an example of the operation of the SNL-SQL translator 130 when a question sentence is inputted. In this example, a user inputs elements of the SNL sentence “what like Mary?”. It should be noted that the user inputs “?” (question mark) in the terminator pull-down menu 2154 for termination. As described above, the structured natural language sentence composition module 120 receives elements of a sentence in SNL and the output it to the operation of the SNL-SQL translator 130 is shown in FIG. 18.

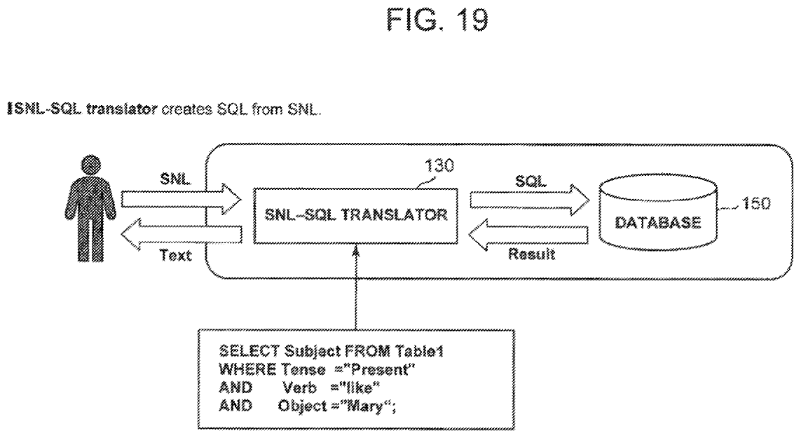

As shown in FIG. 19, the SNL-SQL translator 130 creates SQL queries from SNL. The SNL-SQL translator 130 inquires the database 150 by SQL. The SNL-SQL translator 130 selects a subject, where the tense is “present”, the verb is “like” and the object is “Mary”, from the database 150.

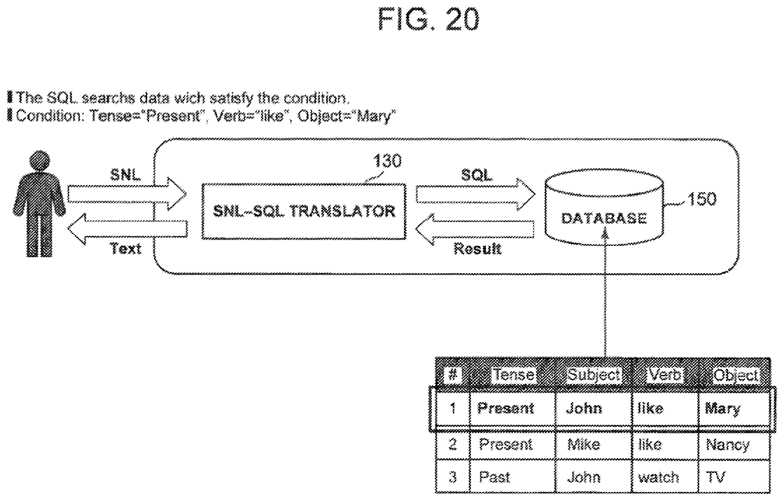

As shown in FIG. 20, the database 150 stores the elements “Present”, “John”, “like” and “Mary” as shown in Table 1. The SQL query searches data which satisfy the condition. Here, the condition under that the tense is “present”, the verb is “like” and the object is “Mary”. As a result, the database 150 returns “John”.

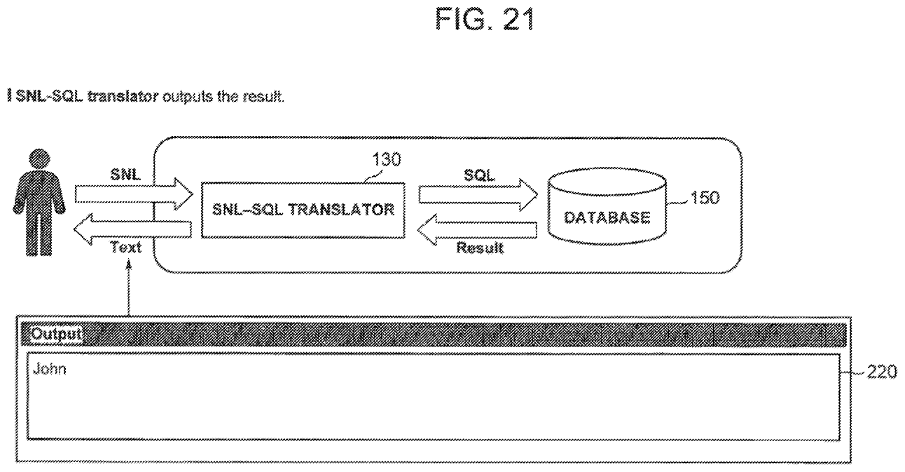

As shown in FIG. 21, the SNL-SQL translator 130 outputs the text “John”. The output from the SNL-SQL translator 130 is displayed in the output segment 220 on the screen 201.

### Question Generator (May Move the Section to the End.)

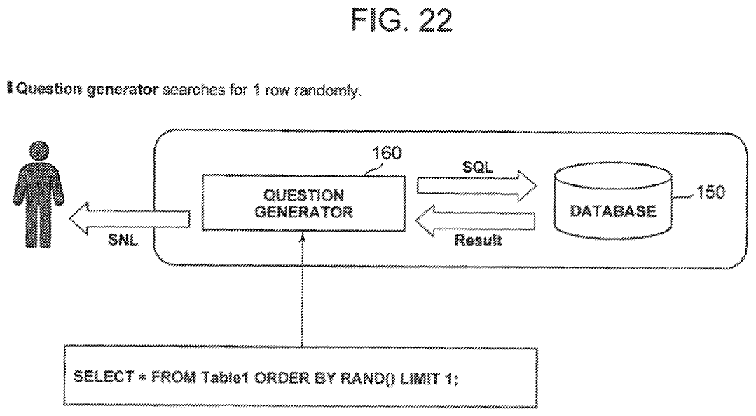

FIGS. 22-25 illustrate an example of the operation of the question generator 160.

As shown in FIG. 22, in this example, the question generator 160 searches for one row randomly. An example of SQL is shown in FIG. 22.

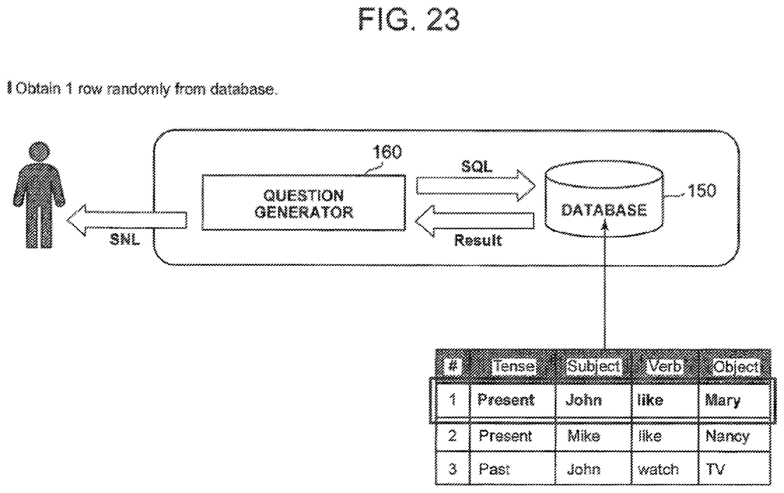

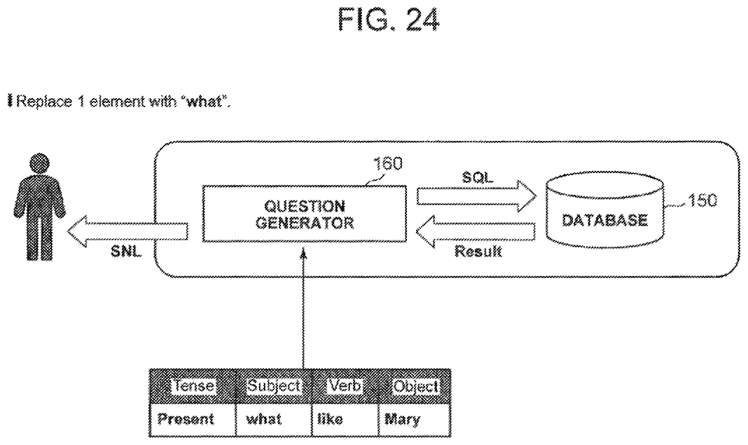

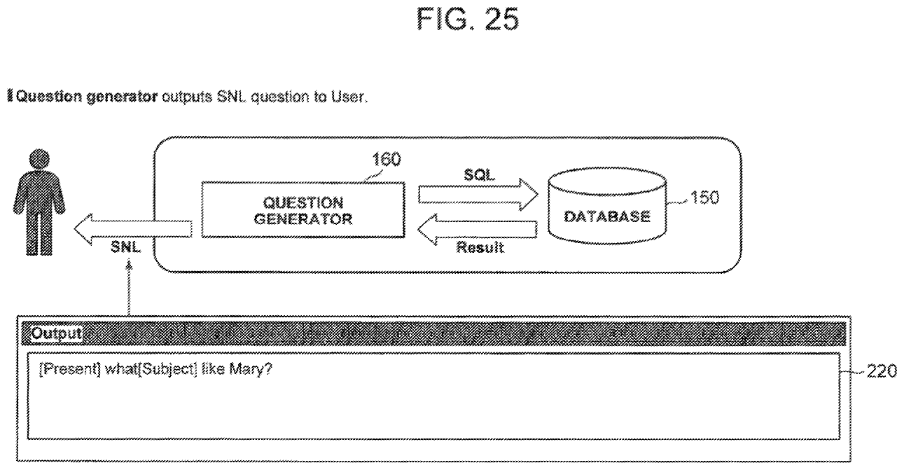

As shown in FIG. 23, the database 150 stores at least 3 rows in Table 1. The question generator 160 obtains one row randomly from the database 150. The question generator 160 replaces one (first) element, i.e. “John” as the “Subject” with “What” as shown in FIG. 24. Further, the question generator 160 outputs the question in SNL. The output from the question generator 160 is displayed on the output segment 220 on the screen 201 as shown in FIG. 25.

Following are examples of various sentence patterns shown in FIG. 3.

### Composing a Sentence Whose Pattern is S+V

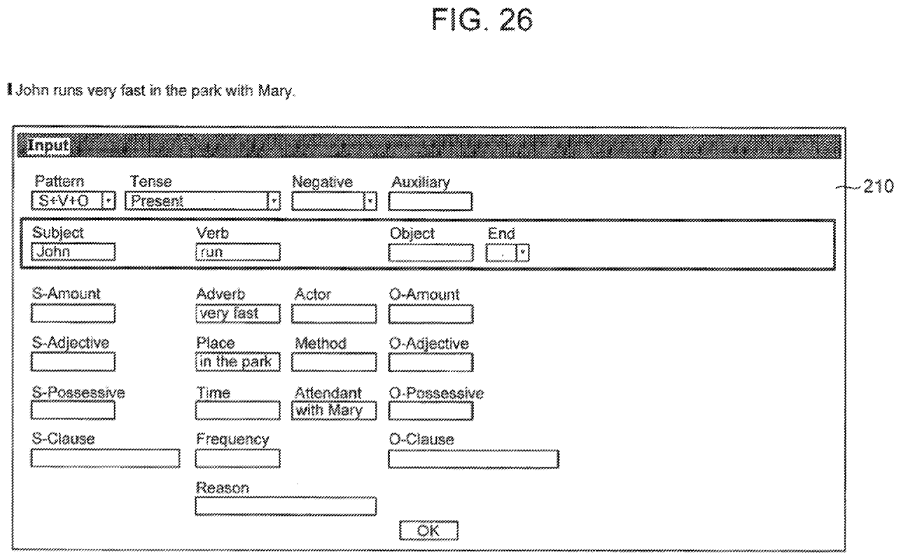

FIG. 26 illustrates a screen 201 when a user inputs elements of a sentence including a subject and a verb (S+V). An exemplary sentence is “John runs very fast in the park with Mary.”

The user inputs “John” as the subject. The user inputs “run” as the verb.

In this example, the user further inputs “very fast” to “Adverb”, “in the park” to “Place”, and “with Mary” to “Attendant” in the subject subarea 2161 and the verb subarea 2162 (refer to FIG. 5). That is how the structured natural language sentence composition module 120 receives elements of a sentence whose pattern is S+V.

### Composing a Sentence Whose Pattern is S+V+C

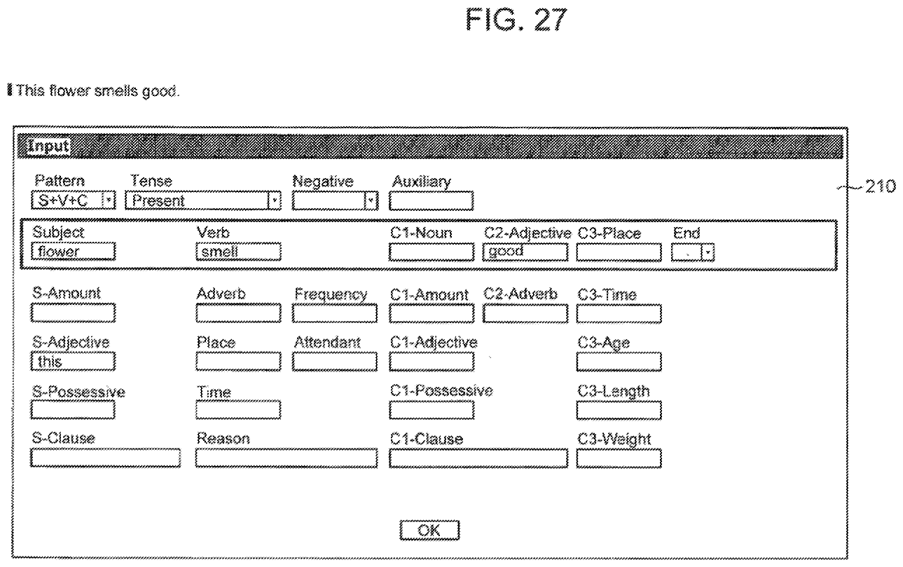

FIG. 27 illustrates a screen 201 when a user inputs elements of a sentence including a subject, a verb and a complement (S+V+C). An exemplary sentence is “This flower smells good.”

The user inputs “flower” as the subject. The user inputs “smell” as the verb. The user inputs “good” as the adjective. In this case, in the word input area 215, there are a C-1 Noun input box, a C2-Adjective input box and a C3-Place input box, instead of the object input box 2153.

In this example, the user further inputs “this” to “S-Adjective” in the subject subarea 2161 (refer to FIG. 5). That is how the structured natural language sentence composition module 120 receives elements of a sentence whose pattern is S+V+C.

### Composing a Sentence Whose Pattern is S+V+O

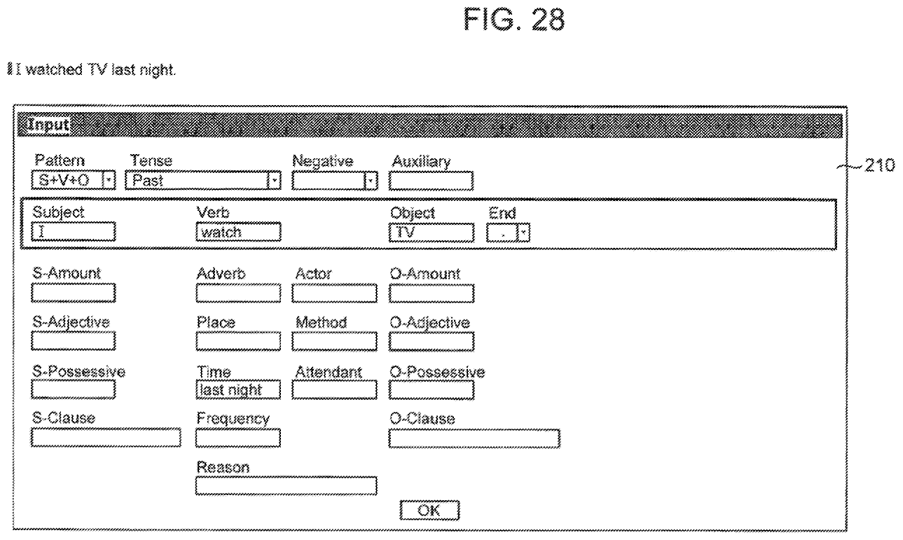

FIG. 28 illustrates a screen 201 when a user inputs elements of a sentence including a subject, a verb and an object (S+V+O). An exemplary sentence is “I watched TV last night.”

The user inputs “I” as the subject. The user inputs “watch” as the verb. The user inputs “TV” as the object. It should be noted that the user selects “Past” from the tense pull-down menu 212.

In this example, the user further inputs “last night” to “Time” in the verb subarea 2162 (refer to FIG. 5). That is how the structured natural language sentence composition module 120 receives elements of a sentence whose pattern is S+V+O.

### Composing a Sentence Whose Pattern is S+V+IO+DO

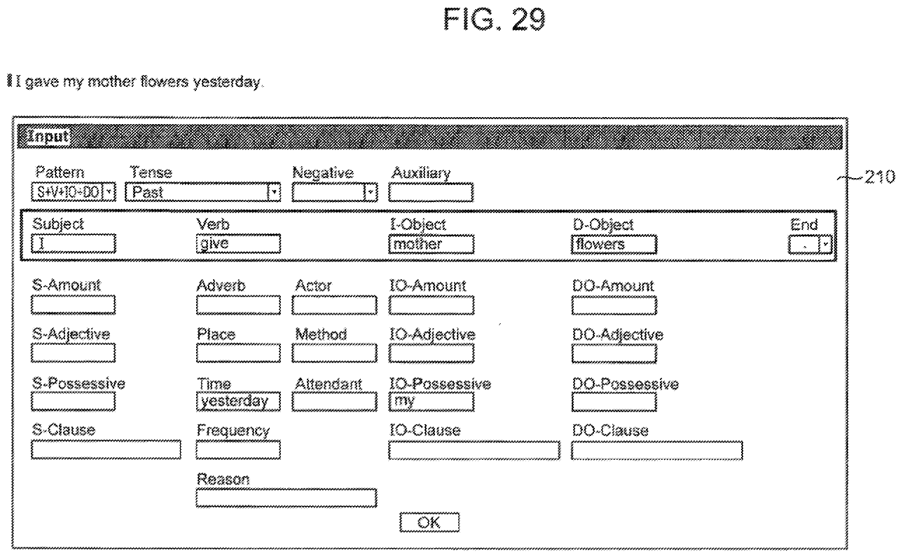

FIG. 29 illustrates a screen 201 when a user inputs elements of a sentence including a subject, a verb, an object, an indirect object and a direct object (S+V+IO+DO). An exemplary sentence is “I gave my mother the flowers yesterday.”

The user inputs “I” as the subject. The user inputs “give” as the verb. The user inputs “mother” as the indirect object. The user inputs “flowers” as the direct object. It should be noted that the user selects “Past” from the tense pull-down menu 212.

In this example, the user further inputs “yesterday” to “Time” in the verb subarea 2162 (refer to FIG. 5), and “my” to “IO-Possessive” in the object subarea 2163 (refer to FIG. 5). That is how the structured natural language sentence composition module 120 receives elements of a sentence whose pattern is S+V+IO+DO.

### Composing a Sentence Whose Pattern is S+V+O+C

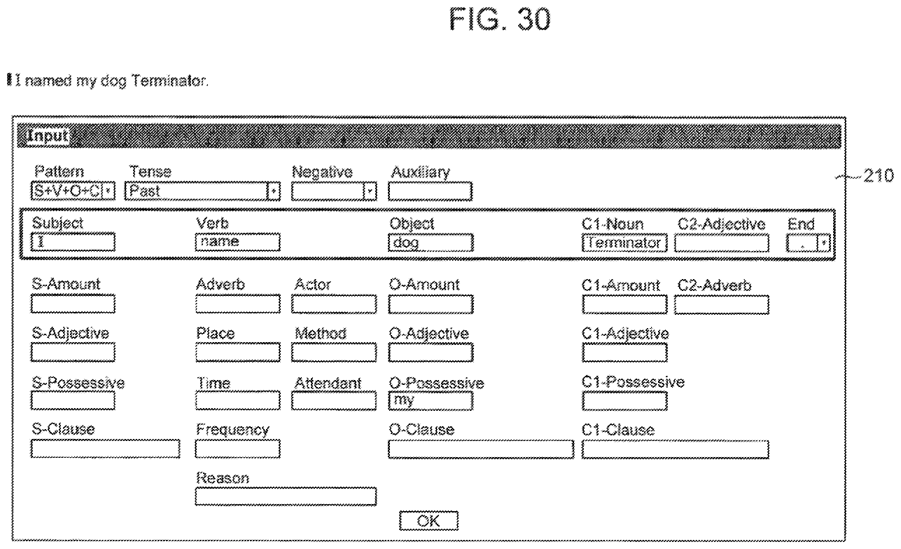

FIG. 30 illustrates a screen 201 when a user inputs elements of a sentence including a subject, a verb, an object, and a complement (S+V+O+C). An exemplary sentence is “I named my dog Terminator.”

The user inputs “I” as the subject. The user inputs “name” as the verb. The user inputs “dog” as the object. It should be noted that the user selects “Past” from the tense pull-down menu 212. In this case, in the word input area 215, there are a C1-Noun input box (C1-Noun) and a C2-Adjective input box (C2-Adjective), instead of the object input box 2153.

In this example, the user further inputs “my” to “O-Possessive” in the object subarea 2163 (refer to FIG. 5). That is how the structured natural language sentence composition module 120 receives elements of a sentence whose pattern is S+V+O+C.

### Composing a Comparative Sentence

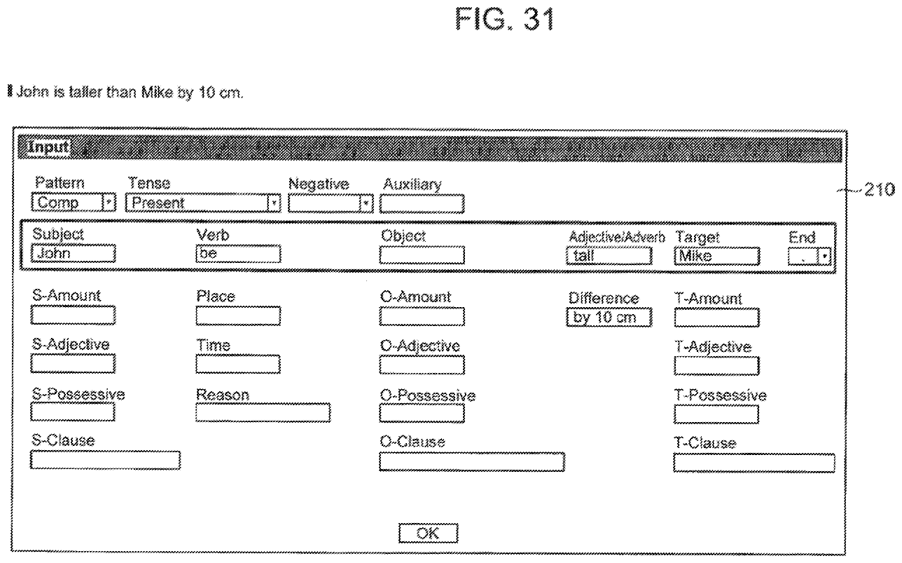

FIG. 31 illustrates a screen 201 when a user inputs elements of a comparative sentence (Comparative). An exemplary sentence is that John is taller than Mike by 10 cm.

The user inputs “John” as the subject. The user inputs “be” as the verb. It should be noted that the user selects “Comp” from the pattern pull-down menu 211. In this case, in the word input area 215, an adjective/adverb input box (“Adjective/Adverb”) and a target input box (“Target”) are added. The user further inputs “tall” to “Adjective/Adverb”, and “Mike” to “Target”.

In this example, the user further inputs “by 10 cm” to “Difference” in the subarea. That is how the structured natural language sentence composition module 120 receives elements of a comparative sentence.

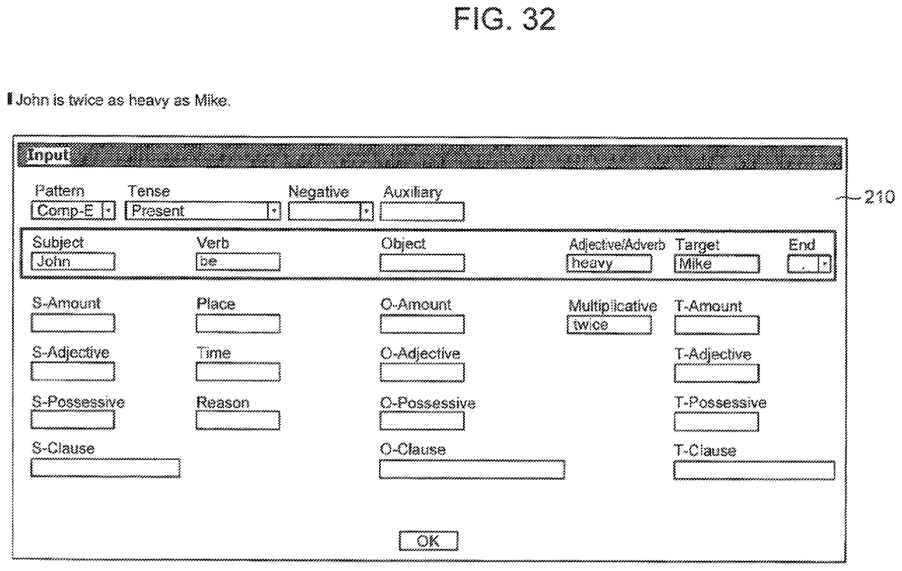

FIG. 32 illustrates a screen 201 when a user inputs elements of a sentence including comparisons of equality (Comparative-Equality). An exemplary sentence is “John is twice as heavy as Mike.”

The user inputs “John” as the subject. The user inputs “be” as the verb. It should be noted that the user selects “Comp-E” from the pattern pull-down menu 211. In this case, in the word input area 215, an adjective/adverb input box (“Adjective/Adverb”) and a target input box (“Target”) are added. The user further inputs “heavy” to “Adjective/Adverb”, and “Mike” to “Target”.

In this example, the user further inputs “twice” to “Multiplicative” in the subarea. That is how the structured natural language sentence composition module 120 receives elements of a comparative sentence.

### Composing a Superlative Sentence

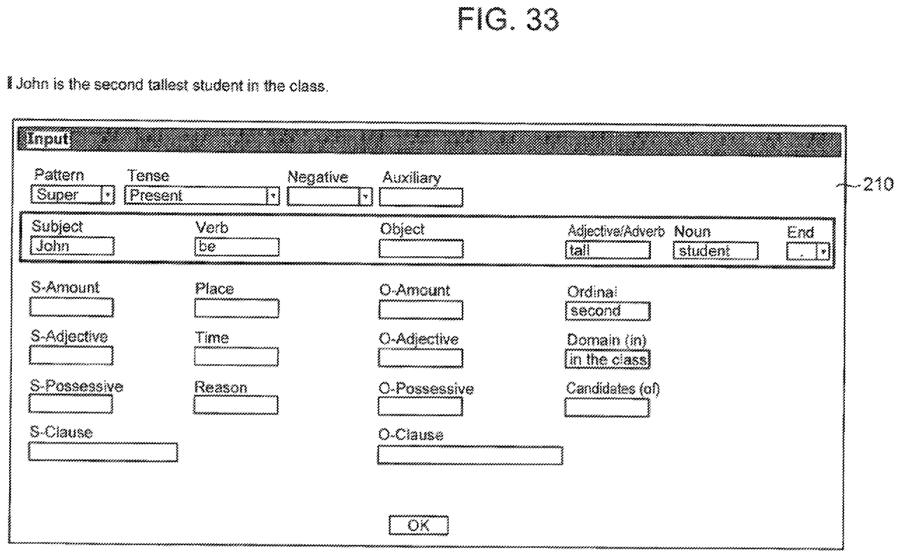

FIG. 33 illustrates a screen 201 when a user inputs elements of a superlative sentence (Superlative). An exemplary sentence is “John is the second tallest student in the class.”

The user inputs “John” as the subject. The user inputs “be” as the verb. It should be noted that the user selects “Super”, i.e. “Superlative”, as the pattern. In this case, in the word input area 215, an adjective/adverb input box (“Adjective/Adverb”) and a Noun input box (“Noun”) are added. The user further inputs “tall” to “Adjective/Adverb”, and “student” to “Noun”.

In this example, the user further inputs “second” to “Ordinal” in the subarea, and “in the class” to “Domain” in the subarea. That is how the structured natural language sentence composition module 120 receives elements of a superlative sentence.

Composing a Sentence that Includes Elements of an Adverbial Syntax

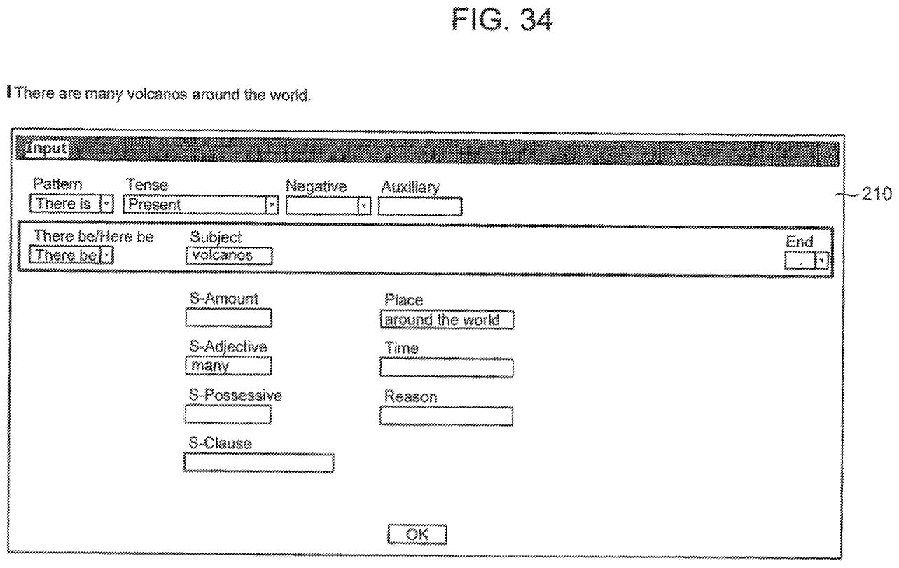

FIG. 34 illustrates a screen 201 when a user inputs elements of an adverbial syntax (There is/Here is). An exemplary sentence is “There are many volcanos around the world.”

In this case, in the word input area 215, a there be/here be input box (“There be/Here be”) is added. The user inputs “There be” as “There be/Here be”. The user inputs “volcanos” as the subject. It should be noted that the user selects “There is” as the pattern.

In this example, the user further inputs “many” to “S-Adjective” in the subject subarea 2161 (refer to FIG. 5). In addition, the user inputs “around the world” to “Place” in the subarea. That is how the structured natural language sentence composition module 120 receives elements of a sentence that includes elements of an adverbial syntax.

While the present invention has been described with reference to the example embodiments and examples, the present invention is not limited to the aforementioned example embodiments and examples. Various changes understandable to those skilled in the art within the scope of the present invention can be made to the structures and details of the present invention.

Each of the foregoing example embodiments may be realized by hardware or a computer program.

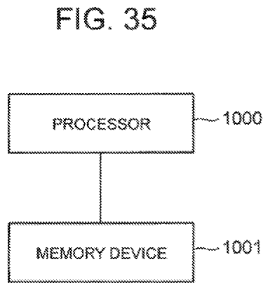

An information processing system shown in FIG. 35 includes at least a processor 1000 and a memory device 1001 for storing. The memory device 1001 may be separate storage media. A magnetic storage medium such as a hard disk or a semiconductor memory is available as the memory device 1001.

In the information processing system shown in FIG. 35, a program for realizing the functions and operations of the blocks shown in FIG. 1 is stored in the memory device 1001. The processor 1000 realizes the functions and operations of the structured natural language knowledge system described in each of the foregoing example embodiments, by executing processes according to the program stored in the memory device 1001.

The foregoing example embodiments may be partly or wholly described in the following supplementary notes, though the structure of the present invention is not limited to such.

Incremental Composition with Interactions

A sentence may be composed incrementally. For example, a sentence of pattern S+V+O may be expanded to a sentence of pattern S+V+O+C if the sentence composition module prompts the user if one or more complements can be added to the sentence. Indeed, a sentence can be expanded into a longer sentence as more details are added. For example, the sentence “John likes Mary.” can be expanded to “John who lives in Irvine likes Mary.” which can further expanded to “John who lines in Irvine likes Mary who lives in San Diego.”, and so on.

(Supplementary note 1) A structured natural language knowledge system, the system comprised of:

a structured natural language sentence composition module which composes an SNL (Structured Natural Language) sentence, and

a sentence translator which translates an SNL descriptive sentence or an SNL question sentence to SQL (Structured Query Language) queries so that the components of a descriptive or question sentence are stored in a database.

(Supplementary note 2) The structured natural language knowledge system of Supplementary note 1,

wherein the sentence translator includes an SNL-SQL translator which translates an SNL descriptive sentence to SQL queries for storing elements of the SNL descriptive sentence to a database, and translates an SNL question sentence to SQL queries for inquiring of the database.

(Supplementary note 3) The structured natural language knowledge system of Supplementary note 1,

wherein the sentence translator includes a question generator which creates an SNL question sentence using the data in a database, and retrieves elements of the sentence from the database using SQL for creating the SNL question sentence.

(Supplementary note 4) The structured natural language knowledge system of Supplementary note 1,

wherein the structured natural language sentence composition module displays the different components of a sentence and prompts a user to enter the values of some or all of the different components in a sentence, wherein a component of a sentence may be at least one of a subject, an object, a verb, a compliment, an adverb and an adjective.

(Supplementary note 5) The structured natural language knowledge system of Supplementary note 4,

wherein the sentence pattern may be “S+V” and its components include a Subject which can have modifiers such as an Amount, an Adjective, a Possessive and a Clause and a Verb, wherein Subject can have modifiers such as an Amount, an Adjective, a Possessive and a Clause, Verb can have modifiers such as an Adverb, a Place, a Time, a Frequency, a Reason, an Actor, a Method and an Attendant (See FIG. 26).

(Supplementary note 6) The structured natural language knowledge system of Supplementary note 4,

wherein the sentence pattern may be “S+V+C” and its components include a Subject, a Verb, C1-Noun, C2-Adjective, C3-Place, C3-Time, C3-Age, C3-Length and a C3-Weight, wherein Subject can have modifiers such as an Amount, an Adjective, a Possessive and a Clause, Verb can have modifiers such as an Adverb, a Place, a Time, a Frequency, a Reason, an Actor, a Method and an Attendant, C1-Noun can have modifiers such as an Amount, an Adjective, a Possessive and a Clause, and C2-Adjective can have modifier an Adverb (See FIG. 27).

(Supplementary note 7) The structured natural language knowledge system of Supplementary note 4,

wherein the sentence pattern may be “S+V+O” and its components include a Subject, a Verb and an Object. Subject can have modifiers such as an Amount, an Adjective, a Possessive and a Clause, wherein Verb can have modifiers such as an Adverb, a Place, a Time, a Frequency, a Reason, an Actor, a Method and an Attendant, and Object can have modifiers such as an Amount, an Adjective, a Possessive and a Clause (See FIG. 28).

(Supplementary note 8) The structured natural language knowledge system of Supplementary note 4,

wherein the sentence pattern may be “S+V+IO+DO” and its components include a Subject, a Verb, an I-Object and a D-Object, wherein Subject can have modifiers such as an Amount, an Adjective, a Possessive and a Clause, Verb can have modifiers such as an Adverb, a Place, a Time, a Frequency, a Reason, an Actor, a Method and an Attendant, I-Object can have modifiers such as an Amount, an Adjective, a Possessive and a Clause, and D-Object can have modifiers such as an Amount, an Adjective, a Possessive and a Clause (See FIG. 29).

(Supplementary note 9) The structured natural language knowledge system of Supplementary note 4,

wherein the sentence pattern may be “S+V+O+C” and its components include a Subject, a Verb, an Object, a C1-Noun and a C2-Adjective, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, C1-Noun can have modifiers such as an Amount, an Adjective, a Possessive and a Clause, and C2-Adjective can have modifier an Adverb (See FIG. 30).

(Supplementary note 10) The structured natural language knowledge system of Supplementary note 4,

wherein the sentence pattern may be “Comp” and its components include a Subject, a Verb, an Object, an Adjective/Adverb and a Target, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, Adjective/Adverb can have modifier a Difference, and Target can have modifiers such as an Amount, an Adjective, a Possessive and a Clause (See FIG. 31).

(Supplementary note 11) The structured natural language knowledge system of Supplementary note 4,

wherein the sentence pattern may be “Comp-E” and its components include a Subject, a Verb, an Object, an Adjective/Adverb and a Target, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, Adjective/Adverb can have modifier a Multiplicative, and Target can have modifiers such as an Amount, an Adjective, a Possessive and a Clause (See FIG. 32).

(Supplementary note 12) The structured natural language knowledge system of Supplementary note 4,

wherein the sentence pattern may be “Super” and its components include a Subject, a Verb, an Object, an Adjective/Adverb and a Noun, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, and Adjective/Adverb can have modifiers such as an Ordinal, a Domain and Candidates (See FIG. 33).

(Supplementary note 13) The structured natural language knowledge system of Supplementary note 4,

wherein the sentence pattern may be “There is” and its components include a There be/Here be and a Subject, wherein Subject can have modifiers such as an Amount, an Adjective, a Possessive and a Clause, and the sentence can have modifiers such as a Place, a Time and a Reason (See FIG. 34).

(Supplementary note 14) The structured natural language knowledge system of Supplementary note 4,

wherein a sentence pattern may be chosen among a set of sentence patterns by the user to compose a sentence.

(Supplementary note 15) The structured natural language knowledge system of Supplementary note 4,

wherein the structured natural language sentence composition module asks the user to enter the value(s) of one or more components whose value(s) are not known based on what have been entered to develop a more complete sentence incrementally, wherein A component of a sentence may be at least one of a subject, an object, a verb, a compliment, an adverb, and an adjective.

(Supplementary note 16) An SNL-SQL translation method, the method comprised of:

composing an SNL (Structured Natural Language) sentence, and

translating an SNL descriptive sentence or an SNL question sentence to SQL (Structured Query Language) queries so that the components of a descriptive or question sentence are stored in a database.

(Supplementary note 17) The SNL-SQL translation method of Supplementary note 16,

wherein when translating, an SNL descriptive sentence is translated to SQL queries for storing elements of the SNL descriptive sentence to a database, and an SNL question sentence is translated to SQL queries for inquiring of the database.

(Supplementary note 18) The SNL-SQL translation method of Supplementary note 16 or 17, further comprising:

creating an SNL question sentence using the data in a database, and retrieves elements of the sentence from the database using SQL for creating the SNL question sentence.

(Supplementary note 19) The SNL-SQL translation method of Supplementary note 16, 17 or 18, further comprising:

inputting the elements, and outputting an SNL sentence including the elements to a user.

(Supplementary note 20) An SNL-SQL translation program for causing a computer to execute:

composing an SNL (Structured Natural Language) sentence, and

translating an SNL descriptive sentence or an SNL question sentence to SQL (Structured Query Language) queries, and stores the components of an SNL sentence in a database.

(Supplementary note 21) The SNL-SQL translation program of Supplementary note 20, causing the computer to execute:

after translating an SNL descriptive sentence to SQL, storing the elements of the SNL descriptive sentence to a database, translating an SNL question sentence to SQL queries for inquiring of the database.

(Supplementary note 22) The SNL-SQL translation program of Supplementary note 20 or 21, further causing the computer to execute:

creating SQL queries using data in a database, and retrieves elements of a sentence from the database by the SQL queries for creating the SNL question sentence.

(Supplementary note 23) The SNL-SQL translation program of Supplementary note 22, further causing the computer to execute:

inputting the elements, and outputting an SNL sentence including the elements to a user.

(Supplementary note 24) A structured natural language knowledge system, the system comprised of:

a memory storing a software component, and

at least one processor configured to execute the software component to perform:

composing an SNL (Structured Natural Language) sentence, and

translating an SNL descriptive sentence or an SNL question sentence to SQL (Structured Query Language) queries so that the components of a descriptive or question sentence are stored in a database.

(Supplementary note 25) The structured natural language knowledge system of Supplementary note 24, wherein the processor further performs:

displaying the different components of a sentence and prompts a user to enter the values of some or all of the different components in a sentence, wherein a component of a sentence may be at least one of a subject, an object, a verb, a compliment, an adverb and an adjective.

(Supplementary note 26) A computer-implemented method, the method comprised of:

composing an SNL (Structured Natural Language) sentence, and

translating an SNL descriptive sentence or an SNL question sentence to SQL (Structured Query Language) queries so that the components of a descriptive or question sentence are stored in a database.

(Supplementary note 27) A non-transitory computer readable information recording medium storing an SNL-SQL translation program, when executed by a processor, performs:

composing an SNL (Structured Natural Language) sentence, and

translating an SNL descriptive sentence or an SNL question sentence to SQL (Structured Query Language) queries, and stores the components of an SNL sentence in a database.

### REFERENCE SIGNS LIST

100 SNL knowledge system
200 I/O device
120 structured natural language sentence composition module
130 sentence translator (SNL-SQL translator)
150 database
160 question generator
201 screen
210 input area
211 pattern pull-down menu
212 tense pull-down menu
213 negative pull-down menu
214 auxiliary input box
215 word input area
2151 subject input area
2152 verb input area
2153 object input area
2154 terminator input area
2161 subject subarea
2162 verb subarea
2163 object subarea
220 output area
1000 processor
1001 memory device

1. A structured natural language knowledge system, the system comprised of:
a memory storing a software component, and
at least one processor configured to execute the software component to implement:
a structured natural language sentence composition module which composes an SNL (Structured Natural Language) sentence, and
a sentence translator which translates an SNL descriptive sentence to SQL (Structured Query Language) queries so that the components of a descriptive are stored in a database.

2. The structured natural language knowledge system according to claim 1,
wherein the sentence translator includes an SNL-SQL translator which translates an SNL descriptive sentence to SQL queries for storing elements of the SNL descriptive sentence to a database, and translates an SNL question sentence to SQL queries for inquiring of the database.

3. The structured natural language knowledge system according to claim 1,
wherein the sentence translator includes a question generator which creates an SNL question sentence using the data in a database, and retrieves elements of the sentence from the database using SQL for creating the SNL question sentence.

4. The structured natural language knowledge system according to claim 1,
wherein the structured natural language sentence composition module displays the different components of a sentence and prompts a user to enter the values of some or all of the different components in a sentence, wherein a component of a sentence may be at least one of a subject, an object, a verb, a complement, an adverb and an adjective.

5. The structured natural language knowledge system according to claim 4,
wherein the sentence pattern may be “S+V” and its components include a Subject and a Verb, wherein Subject can have modifiers such as an Amount, an Adjective, a Possessive and a Clause, Verb can have modifiers such as an Adverb, a Place, a Time, a Frequency, a Reason, an Actor, a Method and an Attendant.

6. The structured natural language knowledge system according to claim 4,
wherein the sentence pattern may be “S+V+C” and its components include a Subject, a Verb, and a complement, wherein Subject can have modifiers such as an Amount, an Adjective, a Possessive and a Clause, Verb can have modifiers such as an Adverb, a Place, a Time, a Frequency, a Reason, an Actor, a Method and an Attendant, wherein the complement can have modifiers such as an Amount, an Adjective, a Possessive and a Clause, and C2-Adjective can have modifier an Adverb.

7. The structured natural language knowledge system according to claim 4,
wherein the sentence pattern may be “S+V+O” and its components include a Subject, a Verb and an Object, wherein Subject can have modifiers such as an Amount, an Adjective, a Possessive and a Clause, Verb can have modifiers such as an Adverb, a Place, a Time, a Frequency, a Reason, an Actor, a Method and an Attendant, and Object can have modifiers such as an Amount, an Adjective, a Possessive and a Clause.

8. The structured natural language knowledge system according to claim 4,
wherein the sentence pattern may be “S+V+IO+DO” and its components include a Subject, a Verb, an I-Object and a D-Object, wherein Subject can have modifiers such as an Amount, an Adjective, a Possessive and a Clause, Verb can have modifiers such as an Adverb, a Place, a Time, a Frequency, a Reason, an Actor, a Method and an Attendant, I-Object can have modifiers such as an Amount, an Adjective, a Possessive and a Clause, and D-Object can have modifiers such as an Amount, an Adjective, a Possessive and a Clause.

9. The structured natural language knowledge system according to claim 4,
wherein the sentence pattern may be “S+V+O+C” and its components include a Subject, a Verb, an Object, a C1-Noun and a C2-Adjective, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, C1-Noun can have modifiers such as an Amount, an Adjective, a Possessive and a Clause, and C2-Adjective can have modifier an Adverb.

10. The structured natural language knowledge system according to claim 4,
wherein the sentence pattern may be “Comp” and its components include a Subject, a Verb, an Object, an Adjective/Adverb and a Target, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, Adjective/Adverb can have modifier a Difference, and Target can have modifiers such as an Amount, an Adjective, a Possessive and a Clause.

11. The structured natural language knowledge system according to claim 4,
wherein the sentence pattern may be “Comp-E” and its components include a Subject, a Verb, an Object, an Adjective/Adverb and a Target, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, Adjective/Adverb can have modifier a Multiplicative, and Target can have modifiers such as an Amount, an Adjective, a Possessive and a Clause.

12. The structured natural language knowledge system according to claim 4,
wherein the sentence pattern may be “Super” and its components include a Subject, a Verb, an Object, an Adjective/Adverb and a Noun, wherein Subject can have modifiers such as an Amount, an Adjective, a Possessive and a Clause, Verb can have modifiers such as an Adverb, a Place, a Time, a Frequency, a Reason, an Actor, a Method and an Attendant, Object can have modifiers such as an Amount, an Adjective, a Possessive and a Clause, and Adjective/Adverb can have modifiers such as an Ordinal, a Domain and Candidates.

13. The structured natural language knowledge system according to claim 4,
wherein the sentence pattern may be “There is” and its components include a “There be/Here be” and a Subject, wherein Subject can have modifiers such as an Amount, an Adjective, a Possessive and a Clause, and the sentence can have modifiers such as a Place, a Time and a Reason.

14. The structured natural language knowledge system according to claim 4,
wherein a sentence pattern may be chosen among a set of sentence patterns by the user to compose a sentence.

15. The structured natural language knowledge system according to claim 4,
wherein the structured natural language sentence composition module asks the user to enter the value(s) of one or more components whose value(s) are not known based on what have been entered to develop a more complete sentence incrementally.

16. A computer-implemented SNL-SQL translation method, the method comprised of:
composing an SNL (Structured Natural Language) sentence, and
translating an SNL descriptive sentence to SQL (Structured Query Language) queries so that the components of a descriptive are stored in a database.

17. The SNL-SQL translation method according to claim 16,
wherein when translating, an SNL descriptive sentence is translated to SQL queries for storing elements of the SNL descriptive sentence to a database, and an SNL question sentence is translated to SQL queries for inquiring of the database.

18. The SNL-SQL translation method according to claim 16, further comprising:
creating an SNL question sentence using the data in a database, and retrieves elements of the sentence from the database using SQL for creating the SNL question sentence.

19. The SNL-SQL translation method according to claim 16, further comprising:
inputting the elements, and outputting an SNL sentence including the elements to a user.

20. A non-transitory computer readable information recording medium storing an SNL-SQL translation program, when executed by a processor, performs:
composing an SNL (Structured Natural Language) sentence, and
translating an SNL descriptive sentence to SQL (Structured Query Language) queries, and stores the components of an SNL sentence in a database.

21.-23. (canceled)
